(19) United States
(12) Patent Application Publication
(10) Pub. No.: US 2008/0196457 A1
(43) Pub. Date: Aug. 21, 2008

(54) Combination lock with light indicators

(76) Inventor: Ilan Goldman, Herzliya (IL)

Correspondence Address: NATH & ASSOCIATES, 112 South West Street, Alexandria, VA, 22314, US

(21) Appl. No.: 12/068,403

(22) Filed: Feb. 6, 2008

Related U.S. Application Data
(60) Provisional application No. 60/900,100, filed on Feb. 8, 2007.

(51) Int. Cl. E05B 13/10

(52) U.S. Cl. 70/224

(57) ABSTRACT

An electromechanical combination lock is provided. It comprises a rotating handle assembly, a locking assembly, an electric actuator and a control mechanism. The locking assembly comprises an actuation device and has an unlocked state thereof in which said handled assembly is rotationally coupled to said actuation device for imparting an opening or closing operation through rotation of the handle and has also a locked state in which said handle assembly is rotationally uncoupled from said actuation device. The electric actuator is operatively associated with the locking assembly for switching the locking assembly between the locked and the unlocked states while in corresponding first and second operational modes of the electric actuator. The control mechanism serves for causing the electric actuator to switch between the two operational modes, and is associated with the rotating handle assembly. The control mechanism comprises one or more sensors for sensing rotational state of the handle assembly, an array of light sources disposed at different circumferential positions of the handle, and control circuitry that is adapted for causing one or more light sources to light at defined rotational states of the handle assembly. The switching into the unlocked state of the locking assembly is encoded in a sequence of the rotational states of the handle assembly, each of which states being indicated by a defined pattern of one or more lighted light source.

### FIELD OF THE INVENTION

The present invention concerns an electromechanical combination lock of the kind having a rotating handle or knob and in which the combination is encoded through a pattern of rotational states.

### BACKGROUND OF THE INVENTION

Electronic locks use an electrical servomechanism to reversibly block locking or unlocking. In some locks, the plunger of the solenoid functions as the bolt or latch of the lock. In other locks, the plunger is configured to reversibly prevent the movement of a separate bolt or latch. In either case, the plunger performs a linear movement or rotation under the influence of electromagnetic forces and elastic elements.

Electronic locks in general are widely known and used as locking mechanisms in doors, windows, boxes, cases, drawers, safes, padlocks, bicycle locks, etc. Some electronic locks have a keypad control panel near the door or on the door itself, which is used to input an entry code. Other types have magnetic card readers for input of the entry code, as used in hotels and some condominiums. Yet others have sophisticated receivers and may be operated remotely, for example door locks of cars.

There are attempts to combine the advantages of the electronic locks and the mechanical locks, especially when retrofitting existing doors with new electronic locks. US Pat. Application 2001/0027671 discloses a system comprising electronic cylinders and electronic keys. The electronic cylinder has no power supply but has a built-in microprocessor and memory chip and electric contacts in a recess accepting the key bit. The electronic key contains a battery to operate the cylinder, and a microprocessor with memory. The key serves also as a handle to turn the cylinder in the lock and to open the lock bolt.

WO 99/61728 discloses an electronic cylinder lock comprising an inner and an outer cylinder plug, a battery, a servo actuator, a control unit, and a mechanical clutch. The servo actuator and the clutch are disposed in the cylinder between the plugs, in a rotary cam engaged with the locking bolt. An electronic key for this lock is described in WO 97/48867. The coded signal is transmitted via electric contacts in the key bit and in a recess in the cylinder plugs. Normally, neither cylinder plug is engaged to the rotary cam. When a key is inserted in one of the plugs and the coded signal is recognized, the servo actuator operates the clutch and connects the plug to the rotary cam.

U.S. Pat. No. 6,411,195 discloses a data transmission system including a data transmitting device having a reciprocable impact head for delivering an encoded series of mechanical impacts to a first surface of an impact transmissive body such as a door, and a data receiving device having a sensitive microphone at a second surface of the impact transmissive body for picking up vibrations resulting from the series of impacts. The data transmission system is suitable for use in coded access systems.

U.S. Pat. No. 6,865,916 discloses a cylinder lock for use in a door lock, comprising an outer plug, an inner plug, a rotary cam adapted to move a deadbolt of the door lock, and a clutch adapted to engage for rotation the outer plug to the rotary cam. The cylinder lock further comprises an electronic blocking device (EBD) and a drive adapted to actuate the clutch upon an unblocking command from the EBD generated upon receiving therein an unblocking signal emitted from the outer side of the door, thereby enabling moving the deadbolt by rotation of the outer plug. The cylinder lock comprises an inner handle attached thereto at the inner side of the door, the EBD and the drive being entirely accommodated within the inner handle. The signal is emitted by an electronic key or panel and may be a mechanical vibration signal, a light signal, or a radio signal.

US Pat. Application No. 2006/0179903 discloses a mechanism for an electromechanical lock. The mechanism comprises a shackle or strike moveable in a bore. A cam is rotatable between a first cam position in which movement of the shackle or strike in the bore is prevented and a second cam position in which movement of the shackle or strike in the bore is not prevented. A blocking pin is moveable between a first pin position in which rotation of the cam is prevented and a second position in which rotation of the cam is not prevented. A solenoid has a plunger having a stable extended position in which movement of the blocking pin is prevented and a stable retracted position in which movement of the blocking pin is not prevented.

While each of the above constructions has its advantages, it is desirable to avoid some deficiencies such as exposure to tampering or malevolent damage, etc.

### SUMMARY OF THE INVENTION

In accordance with the present invention, a new electromechanical combination lock is provided of the kind having a rotational handle and in which the combination is encoded through a sequence of rotational states. In accordance with the present invention, a novel mechanism permitting a user to clearly select the rotational states that define the lock combination is provided. This is achieved in accordance with the invention through including a plurality of light sources, for example light-emitting diodes (LEDs) disposed in circumferential, spaced-apart location of the rotational handle or knob of the lock. In each of a number of defined rotational states of the lock, a certain pattern of light sources lights up and by ensuring a correct sequence of lighting up pattern, the lock may be opened. In accordance with one preferred embodiment, at each of the defined rotational states, a single light source lights up.

In accordance with one embodiment there is provided an electromechanical combination lock comprising a rotating handle assembly; a locking assembly comprising an actuation device and having an unlocked state thereof in which said handled assembly is rotationally coupled to said actuation device for imparting an opening or closing operation through rotation of the handle and having a locked state in which said handle assembly is rotationally uncoupled from said actuation device; an electric actuator operatively associated with the locking assembly for switching the locking assembly between the locked and the unlocked states while in corresponding first and second operational modes of the electric actuator; and a control mechanism for causing said electric actuator to switch between the two operational modes, said control mechanism being associated with the rotating handle assembly, and comprising one or more sensors for sensing rotational state of the handle assembly, an array of light sources disposed at different circumferential positions of the handle, and control circuitry, said circuitry being adapted for causing one or more light sources to light at defined rotational states of the handle assembly, the switching into the unlocked state of the locking assembly being encoded in a sequence of the rotational states of the handle assembly, each of which states being indicated by a defined pattern of one or more lighted light source.

In accordance with one embodiment of the invention, each of the defined patterns is associated with the lighting up of one or more of light sources.

In accordance with some embodiments of the present invention, the pattern of lighted light sources is formed by light sources that light up in a defined spatial and time-dependent pattern. In accordance with such embodiment, the control circuitry is operative to actuate a light source in such a manner to ensure a time-dependent variation in light intensity. For example, the light source may be lit up for a defined time period, lighting up of the light sources may have a time-dependent intensity profile or the lighting up may have a time-dependent color profile. This ensures that only if the handle is kept in a defined operational state for at least a minimal time period, a selection of such an operational state will be recorded.

As will be appreciated, even a relatively limited number of rotational states each associated with a unique and defined light pattern, may give rise to the ability to encode a practically infinite number of rotational state sequences to define a unique unlocking combination code.

It should be understood that the sequence of rotational positions may be attained through registration of defined marks on the handle with a certain fixed location in a non-rotating part of the lock. For example, numerals may be printed on the handle spaced-apart from one another along the circumference of the handle, with the correct registration being for example with the respective numeral facing upwards, sideward, downwards, in an oblique angle, etc. If for example the numeral combination is 6-3-4-5 then the numeral “6” is to be brought to the fixed position, then the “3” is to be brought to said position, etc. Once in the fixed position, the handle is in one of the defined rotational states which once sensed by the sensor causes the electric circuitry to power one or more light sources giving rise to a certain light pattern. For example, there may be a single light source associated with each numeral and said light pattern may be lighting up of the numeral associated light source. In some embodiments of the invention, the handle has to remain in the specific rotational state at least for a certain period of time, e.g. at least 0.5-1 sec in order for this rotational state to be identified as part of the defined rotational states sequence. In the case of the example where each of such rotational states is associated with a specific numeral this means that for such a numeral to be “entered” the handle needs to be retained with the respective numeral in the specific position for at least a define period of time. In this way, accidental recording of numeral may be avoided.

The lighting up of the respective light sources at the defined rotational state provide the needed indication that proper registration to yield one of the defined rotational states has been achieved. The light emission, according to some embodiments of the invention, may include a time-dependent pattern of the intensity, color, etc. to ensure that the user maintains the handle at a selected position of at least a required minimal time. In accordance with one non-limiting embodiment, the light source (e.g. LED) is lighted up upon said registration with a short off-blink to indicate that the minimal time has been achieved.

It should also be noted that the “light source” located on and rotating with the handle assembly may be a light emitter (e.g. LED) or an optical window associated with a stationary mounted light emitter. Thus, in some embodiments of the invention, the rotatable handle assembly carries an array of light emitters (constituting the array of light sources). In some other embodiments, the rotatable handle assembly is formed with an array of optical windows, such as apertures or holes (constituting the array of light sources) rotating together with respect to a stationary mounted light emitter (e.g. a ring-like light emitter).

Unlocking of the lock is typically for a defined period of time, e.g. between four and ten seconds, following which the lock reverses automatically back to the locked state.

The electromechanical lock of the invention, according to some embodiments, includes a plurality of sensors which in combination may provide an indication as to the rotational state of the lock. For example, the sensing arrangement may include one or more light sources which may either be fixed or rotating with the handle, and corresponding sensors which may either be rotating with the handle or fixed, respectively. By way of another example, the sensor may include a pressure sensor operative to sense the urging force of a fixed plunger device, biased by an urging arrangement so as to press the pressure sensor.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 shows a perspective view of an electromechanical combination lock according to an embodiment of the invention;

FIGS. 2A to 2C show sectional views of the lock of FIG. 1 in three successive operational states;

FIG. 3 is a block diagram of the control mechanism of the lock;

FIG. 4 is a perspective view of a lock in accordance with another embodiment of the invention with an optical sensor arrangement for sensing rotational state (with a handle being made transparent to view the sensor arrangement); and

FIGS. 5A to 5F show the lock of FIG. 4 in a number of defined rotational states.

### DETAILED DESCRIPTION OF EMBODIMENTS

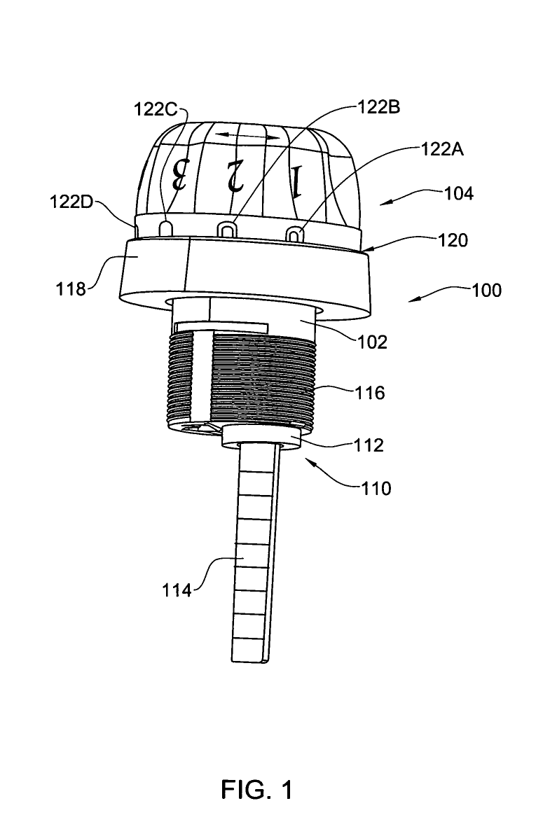

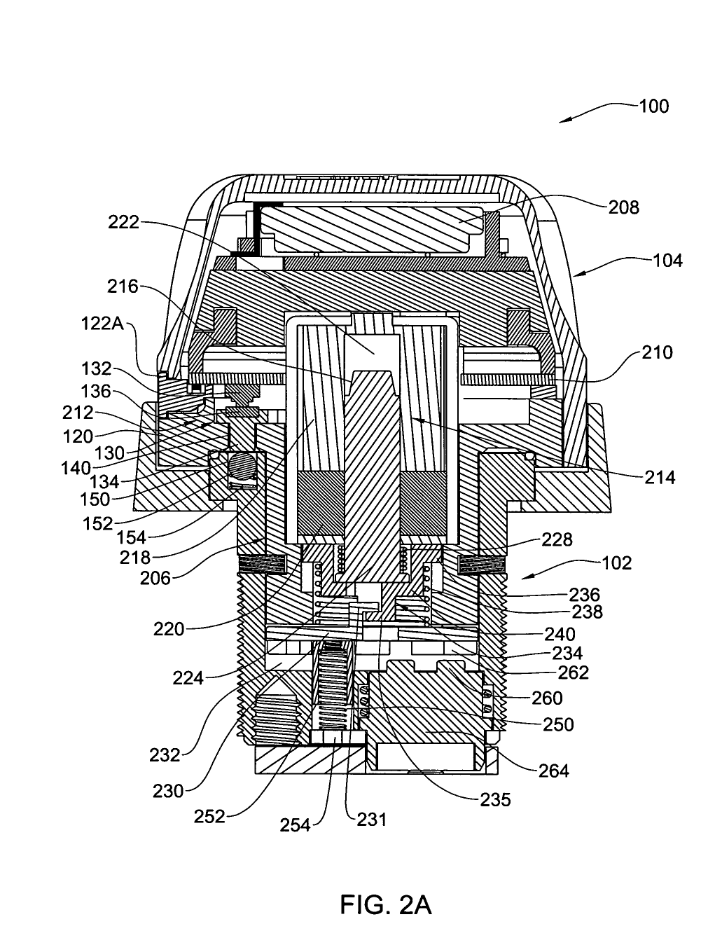

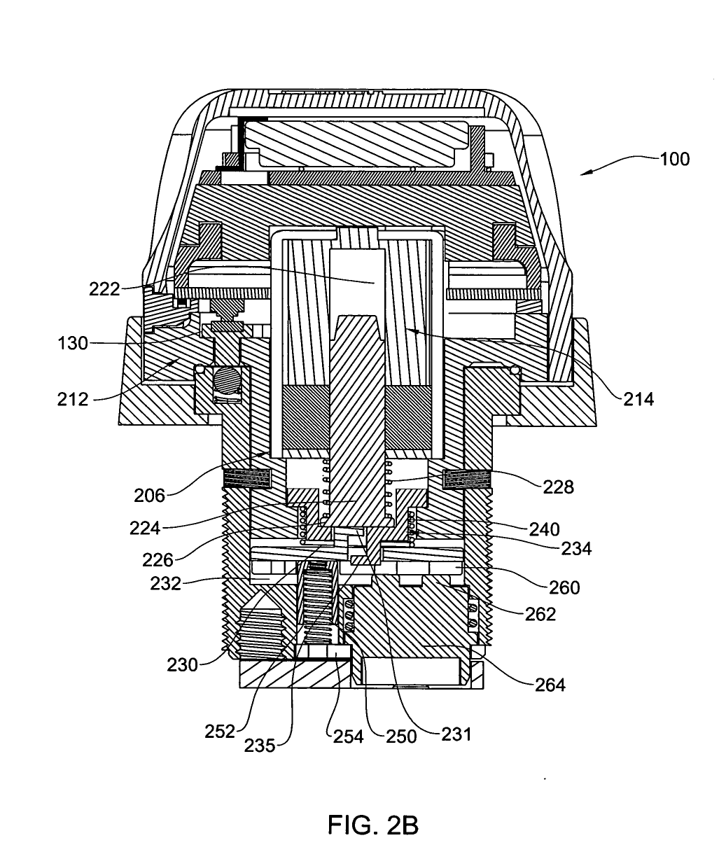

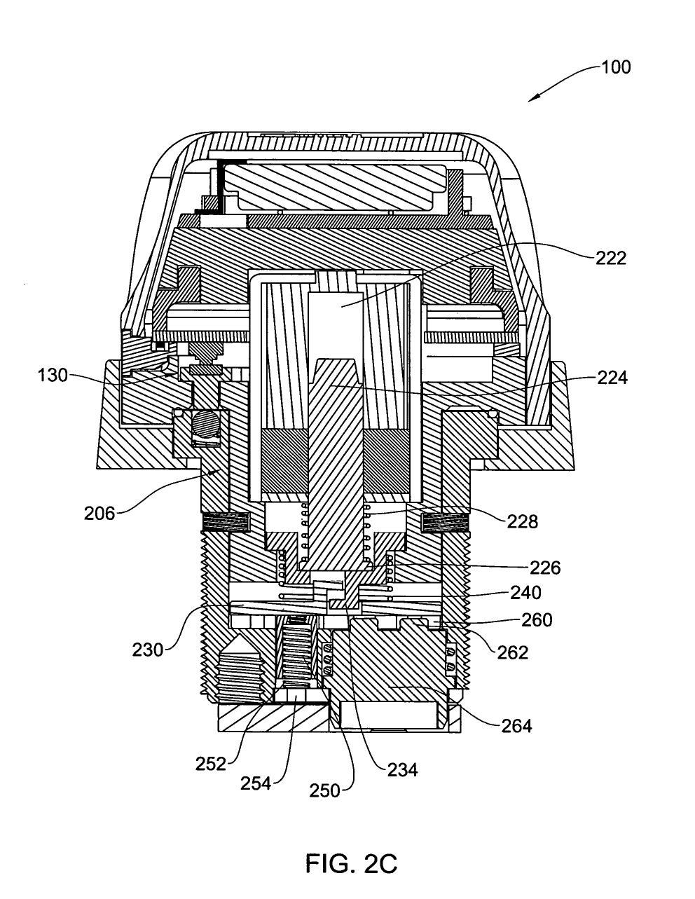

Reference is first being made to FIG. 1 showing a lock generally designated 100 according to an embodiment of the invention. The lock 100 includes a housing 102, a rotating handle assembly 104, and a lock actuation device 110 including in the lock's exterior an external rotating cam member 112 and an actuator extension rod 114, fixed to internal rotational cam 264 which is shown in FIGS. 2A-2C and will be explained further below. The lock of this embodiment is a cylinder lock, and accordingly the actuation device 110 is adapted for fitting with a door mechanism for opening and closing the door.

The housing 102 includes an external threading 116 for screw-type engagement into a door cylinder. The housing 102 further includes a skirt portion 118 fitting around the base 120 of handle 104.

The handle assembly 104 includes an array of light sources, four such light sources 122A-122D being seen in the figure. Each one of the light sources is fitted in a corresponding opening in the housing of the handle assembly and is opposite an engraved numeral, numerals “1” to “4” being seen in the figure.

Longitudinal cross-sections of the lock of FIG. 1 are seen in three operational states in FIGS. 2A-2C of which FIG. 2A shows the lock in a locked state in which the handle assembly 104 is rotationally uncoupled from actuation device 110. As can be seen, cylinder lock handle assembly 104 forms part of a rotational assembly generally designated 206 rotational within the housing 102. Handle assembly 104 includes a battery 208, an electronic circuitry board 210 and a lock control mechanism 212, the operation of which will be described below.

Latch solenoid 214 is accommodated within the lock, constituting part of the rotational assembly, and includes a housing 216, a coil 218 and a fixed magnet 220, all arranged around a cylindrical lumen 222 accommodating a cylindrical plunger 224 with a laterally protruding head 226. The plunger is associated with a first urging spring 228. The solenoid is typically a bi-stable solenoid of the kind disclosed in U.S. Pat. No. 6,865,916. The latch solenoid 214 switches between stables states, including a first, retracted state of the plunger as can be seen in FIG. 2A and a second stable state in which the plunger is extended as can be seen in FIGS. 2B and 2C. The switch between the states is through an appropriate electrical signal issued by an electronic mechanism incorporated within board 210.

Rotational assembly 206 incorporates a locking assembly including a lock actuation member 230, accommodated within space 232 and an auxiliary actuation member 234 having annular shoulders 236 accommodated within recess 238. Members 230 and 234 can axially displace in a path respectively defined by space 232 and recess 238.

Disposed intermediate members 230 and 234 is a second urging spring 240 which imparts a biasing force to force these two members one away from the other. Each of members 230 and 234 has a respective tooth portion 231 and 235 providing for engagement of these two members to avoid their axial disengagement from one another and arranged such so as to permit relative axial displacement of these two members towards one another.

A third urging spring 250 is partially accommodated within a cylindrical lumen 252 or urging element 254 and has its end rested against base element 254 fitted to the housing. Third urging spring 250 thus provides an axial biasing force to resist axial displacement of member 230 in a first axial direction corresponding to the axial displacement of the plunger from its retracted to its extended state.

Member 230 has a tooth surface 260 adapted for tooth surface 262 of internal rotary cam 264, whereupon engagement rotation of rotary assembly 206 causes rotation of internal rotary cam 264. Internal rotary cam 264 is engaged with external rotating cam member 112 seen in FIG. 1 and thus rotation of rotary assembly 206 activates the door mechanism.

Upon issuing of an activation electric signal, in response to an actuation signal from control mechanism 212, solenoid 214 is activated to displace the plunger 224 from its retracted state as seen in FIG. 2A, in a first axial direction to the retracted state as seen in FIG. 2B. Such displacement also causes corresponding displacement of member 234 causing compression of second spring 240 which thereby gives rise to an axial biasing force on lock actuation member 230 causing its axial displacement against the biasing force of third urging spring 250. The displacement proceeds until the teeth 260 pressed against teeth 262 of rotary cam 264. Upon rotation of rotary assembly teeth 260 and 262 become aligned with respective recesses between teeth 262 and 260 whereby member 230 becomes fully axially displaced into the state as seen in FIG. 2C. In this state rotary handle assembly 206 is rotationally coupled to rotary cam 264, which is the unlocked state of the lock in which rotation of the handle can open the door permitting access.

The mechanism is typically designed such that following a defined period of time, e.g. 5-10 seconds, an opposite actuation signal causes the plunger to displace in an opposite axial direction from its extended to its retracted whereupon the biasing force of the third urging spring 250 can cause axial displacement of the entire lock assembly, consisting of member 230, second urging spring 240 and member 234 in said opposite axial direction to the locked state seen in FIG. 2A.

According to an embodiment of the present invention, the relative strength of the urging springs 228, 240 and 250 is selected so that in the absence of any magnetic force the force of the uncompressed urging spring 228 is greater than the force of the urging spring 240 in its compressed state. The urging spring 240 in its uncompressed state is greater than the strength of the urging spring 250 in its compressed state.

The lock control mechanism 212 includes, in this specific embodiment, a plurality of position sensor units, each of which is associated with one of defined rotational states, and of which one 130 is seen in FIGS. 2A-2C. Sensor unit 130 includes a switch 132, a pin 134 and a switch contact insert 136. Pin 134 has a broad head portion and stem accommodated within a cylindrical bore 140 defined in the base 120 of the handle assembly. Pin 134 is slightly displaceable along its axis against switch 132.

Housing 102 has a cavity 150 accommodating a bearing 152 and a spring 154 that urges the bearing 154 in an axial direction towards pin 134. Thus, when 134 comes into registration with bearing 152, through the urging force of spring 154, the bearing presses pin 134 against switch 130, thus activating the switch. At other times, when the pin and the bearing are not in registration, no axial force is applied on the pin and switch is inactivated. The activation thus provides the electrical signal to indicate proper registration. The proper registration signifies a defined rotational state. At such rotational states, a corresponding LED, such as led 122A, seen in cross-section in FIGS. 2A-2C, lights up.

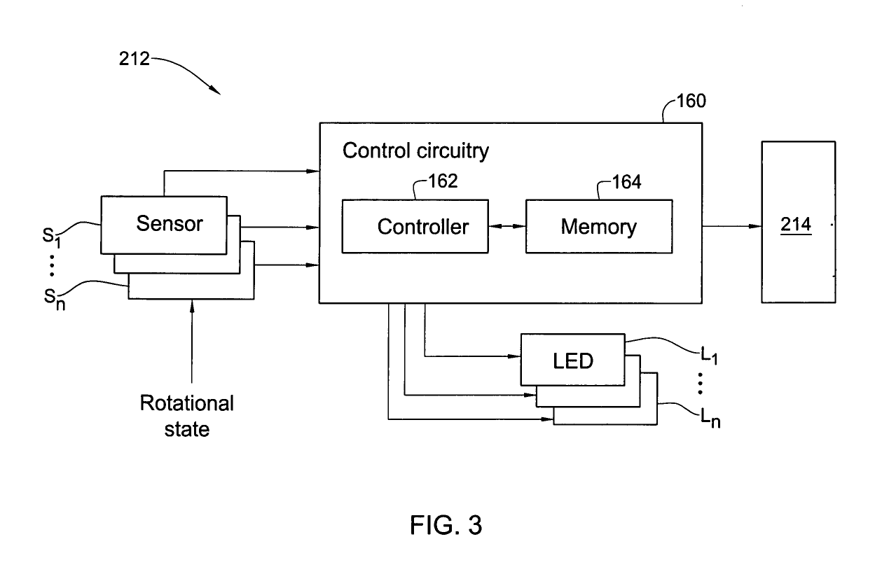

Reference is now being made to FIG. 3 showing a block diagram of the control mechanism 212. It includes a plurality of sensors, S₁-Sₙ, such as sensor units 130 shown in FIGS. 2A-2C. Each of sensors S₁-Sₙ, is linked to a control circuitry 160. Control circuitry 160 includes inter alia a controller utility 162, and a memory utility 164 that stores a unique code in the form of a sequence of defined rotational states. Controller 162 receives input data from each of the sensors S₁-Sₙ, thus recording the corresponding rotational states and identifying whether the recorded sequence corresponds to that stored in memory 164. Typically, in order for a rotational state to be recorded the handle assembly needs to be maintained in a defined rotational state for a minimal time period (e.g. 0.5-1 sec). Only sensing signals that proceed above such minimal time will be recorded.

Once the sensing signal is issued indicating that the handle assembly is in one of defined rotational states, a control signal activates one of the plurality of LEDs L₁-Lₙ such as LEDs 122A-122D in FIG. 1. The LED activation is typically in a manner to include a time signal such as for example turning the LED off after the minimal time period is achieved or inducing a blink in the emitted light after such a minimal time period. This signifies to the user that the rotational state has been recorded and the handle can then be rotated to another rotational state of the sequence of such states. After the encoding sequence of rotational states has been recorded indicative of that the unique code has been entered, control circuitry 160 may operate to cause activation of the solenoid 214 to unlock the lock in the above-described manner.

As seen in FIG. 1, the handle may include a serious of marks, e.g. numerals, engraved or printed on the face of the handle in different circumferential locations. The code may thus be defined in a numerals' sequence. Each defined rotational state that corresponds to a numeral is attained by bringing the numeral to a defined circumferential position. The exact defined rotational state is when the corresponding LED lights up.

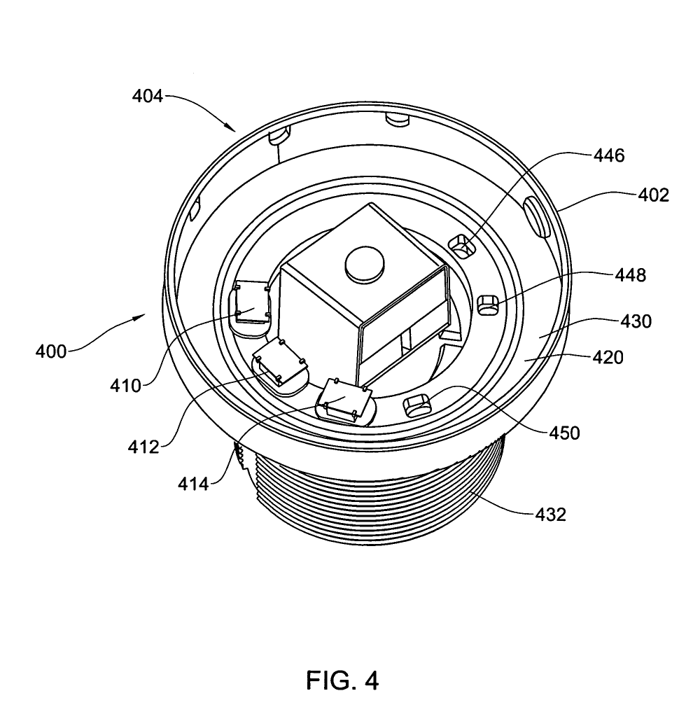

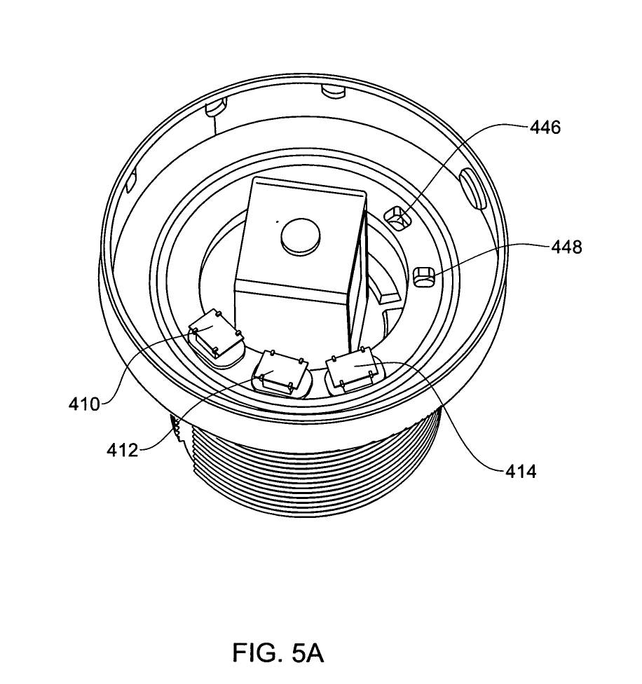

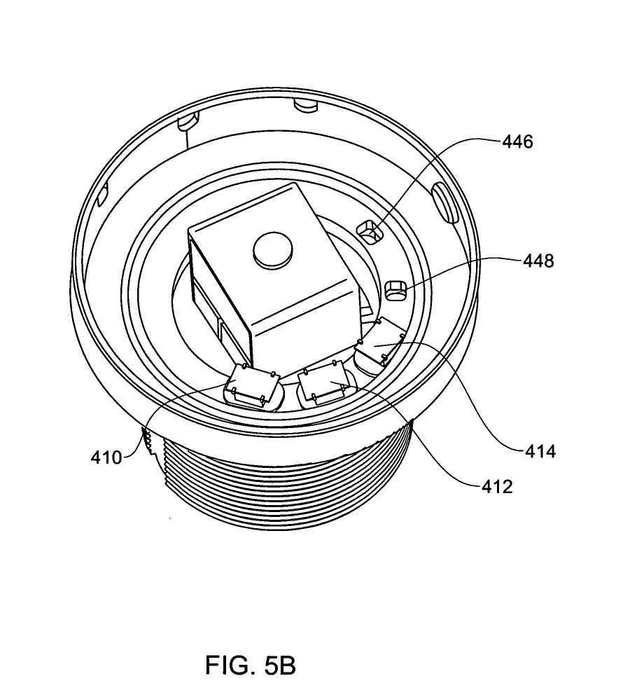

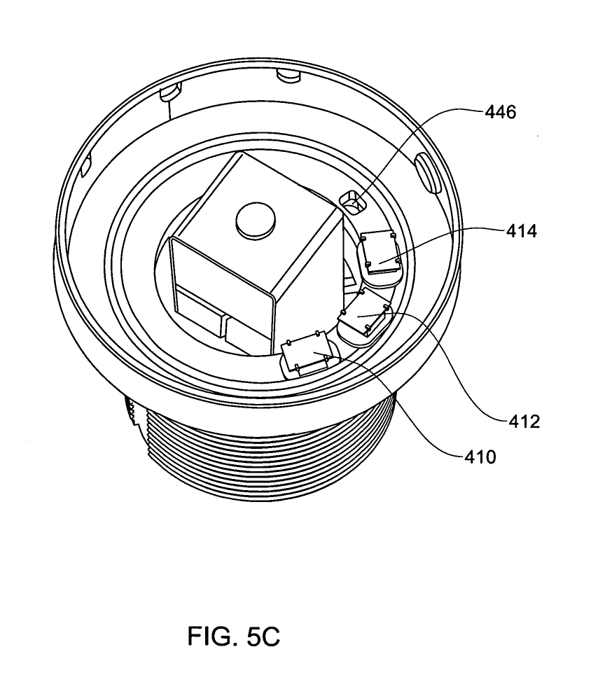

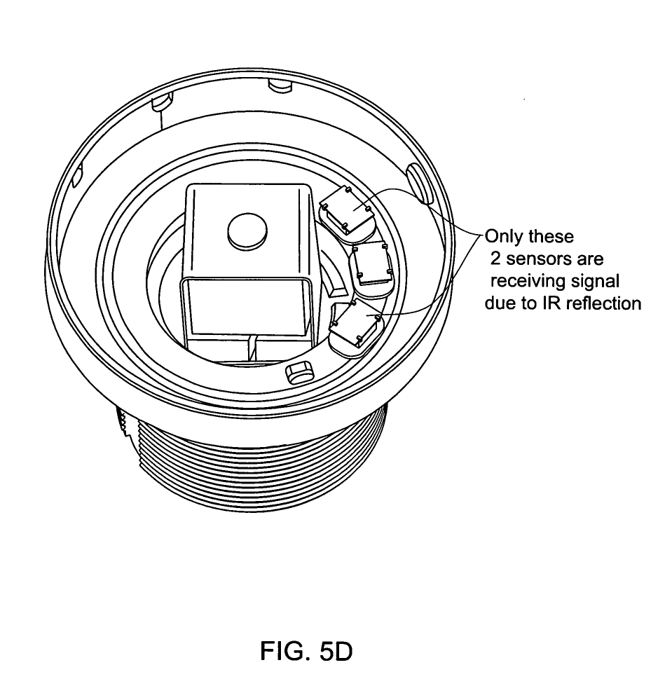

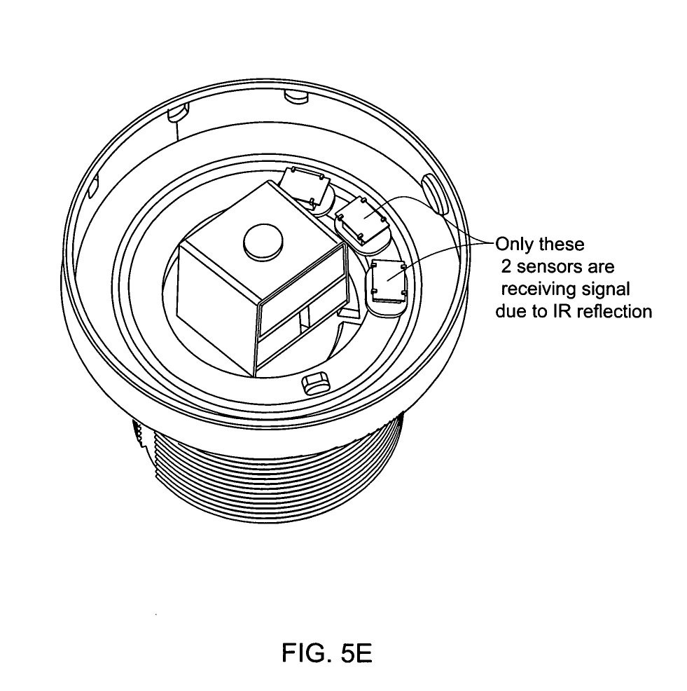

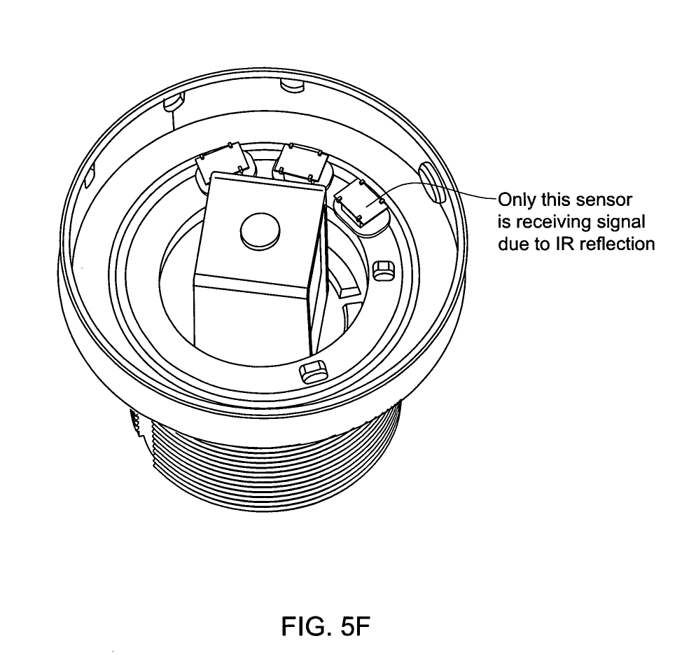

Reference is made to FIG. 4 showing a lock generally at 400 of another embodiment of the invention. For easy viewing, in FIG. 4 housing 402 of the handle assembly has been made transparent and some components have been removed. The lock 300 other than the sensing arrangement that will be discussed below is generally similar in its function to the lock 100 described above, and therefore need not be described in details. The main difference resides in the sensing arrangement 400 which includes three optical transceivers 410, 412 and 414, adapted, in one exemplary embodiment, to transmit an IR signal and record the signal reflection. Sensors 410-414 are configured to emit a downwardly directed IR signal through an optical window 444 at a base 420. Formed at a top end 430 of the lock's housing 432 are three IR reflectors 446, 448 and 450. When one of the three sensors 410-414 is located opposite one of the reflectors, the IR reflection is recorded by the respective sensor. In order to preserve energy, the sensors are activated to emit IR signals only upon rotation. In a manner to be described below with reference to FIGS. 5A-5F, different rotational states can be recorded by registration of one or more of the three sensors with one or more of the three reflectors.

As can also be seen in FIG. 4, marked on the handle are numerals “1”-“5”, and another “Enter” mark. Through bringing these numeral marks to defined rotational positions, the sequence of numerals constituting the code of the lock can be entered. In accordance with this specific embodiment the lock is switched to the unlocked state, following entry of the code through the sequence of defined rotational positions corresponding to the code numerals, the :Enter” is is brought into position and the lock is opened. Included on the face of the handle is a “Low Bat.” which lights up when the battery power dwindles.

FIGS. 5A to 5F show the lock of FIG. 4 in a number of defined rotational states. FIG. 5A is a rotational state corresponding to numeral “1” where sensor 414 is registered with reflector 450. In such a state only sensor 414 receives the signal from the IR reflector, this corresponding to the “1” numeral thus lighting up the associated LED.

In the position shown in FIG. 5B, sensor 412 is registered with reflector 450, and is thereby the only one which receives the reflected IR signal. This corresponds to the “2” numeral leading to the lighting up of the associated LED.

In the rotational state shown in FIG. 5B, sensors 410 and 414 are registered with reflectors 450 and 448, respectively, and these sensors are thus receiving the IR reflected signal. The state where these two sensors receive the signals correspond to the “3” numeral, leading to the lighting up of the associated LED.

FIGS. 5D-5F show respective rotational positions corresponding to numerals “4”, “5” and “Enter” achieved by through other three possible combinations of registration between one or two sensors and one or two reflectors.

It should be noted that the sensor configuration seen in FIG. 4 has the advantage of permitting to minimize the number of transceivers. It is also possible to have one transceiver that corresponds to each numeral or other indicator with a single fixed reflector; the rotational states being then identified upon registration of each of the transceivers with the reflector.

It is also possible, according to the invention, to have other types or configuration of position sensors. One example is a single stationary light source and multiple light sensors in the rotating handle assembly. Also a variety of other mechanical sensors may be used.

As will be appreciated the illustrated embodiments are only exemplary embodiments of the invention, and the invention is not limited thereto. Rather, the invention applies to the full scope thereof as defined above and in the appended claims.

1. An electromechanical combination lock comprising:
a rotating handle assembly;
a locking assembly comprising an actuation device and having an unlocked state thereof in which said handled assembly is rotationally coupled to said actuation device for imparting an opening or closing operation through rotation of the handle and having a locked state in which said handle assembly is rotationally uncoupled from said actuation device;
an electric actuator operatively associated with the locking assembly for switching the locking assembly between the locked and the unlocked states while in corresponding first and second operational modes of the electric actuator; and
a control mechanism for causing said electric actuator to switch between the two operational modes, said control mechanism being associated with the rotating handle assembly, and comprising one or more sensors for sensing rotational state of the handle assembly, an array of light sources disposed at different circumferential positions of the handle, and control circuitry, said circuitry being adapted for causing one or more light sources to light at defined rotational states of the handle assembly, the switching into the unlocked state of the locking assembly being encoded in a sequence of the rotational states of the handle assembly, each of which states being indicated by a defined pattern of one or more lighted light source.

2. A lock according to claim 1, wherein each of the defined patterns is associated with the lighting up of one or more of the light sources.

3. A lock according to claim 1, wherein the light sources are light-emitting diodes (LEDs).

4. A lock according to claim 1, wherein the pattern of lighted light sources is formed by light sources that light up in a defined spatial and time-dependent pattern.

5. A lock according to claim 4, wherein said spatial and time dependent pattern includes a sequence of lighting of the light sources being lighted up in a time-coded mode.

6. A lock according to claim 5, wherein the time-coded mode includes one or more of (i) lighting up for a defined time period, (ii) lighting up with a time-dependent intensity profile, and (iii) lighting up with a time-dependent color profile.
